(19) United States
(12) Patent Application Publication
(10) Pub. No.: US 2008/0248306 A1
(43) Pub. Date: Oct. 9, 2008

(54) Method for Attaching Manoparticles to Substrate Particles

(75) Inventors: Adrian Spillmann, Zurich (CH); Axel Sonnenfeld, Zurich (CH); Philipp Rudolf Von Rohr, Muttenz (CH)

Correspondence Address: BROWDY AND NEIMARK, P.L.L.C.;624 NINTH STREET, NW, SUITE 300, WASHINGTON, DC, 20001-5303, US

(73) Assignee: ETH Zurich, ETH Transfer, Zurich (CH)

(21) Appl. No.: 12/088,421

(22) PCT Filed: Sep. 25, 2006
(86) PCT No.: PCT/CH2006/000517

§ 371 Date: Mar. 27, 2008

Related U.S. Application Data
(60) Provisional application No. 60/721,209, filed on Sep. 27, 2005.

(30) Foreign Application Priority Data
Dec. 23, 2005 (CH) 2058/05

(51) Int. Cl. B05D 7/00; H05H 1/24; B32B 5/16

(52) U.S. Cl. 428/403; 118/716; 427/569

(57) ABSTRACT

The invention relates to the deposition of nanoparticles from the gas phase of the a thermal plasma of a gas discharge and the subsequent attachment of said nanoparticles to the substrate particles. The invention can be used for increasing the flowability of solid bulk material. Particularly the pharmaceutical industry utilizes numerous intermediate and final products in the form of powders which cause processing problems because of the poor flowability thereof. With fine-grained materials, undesired adhesive effects occur foremost because of Van der Waals'forces. Said effects can be reduced by applying nanoparticles to the surface of the material that is to be treated. The invention is characterized by a combined process in which the nanoparticles are produced and are attached to the substrate surface. Using a non-thermal plasma additionally makes it possible to treat temperature-sensitive materials that are often used in the pharmaceutical industry.

### TECHNICAL FIELD

The present invention relates to a method for attaching nanoparticles to substrate particles.

### PRIOR ART

The processing of solids is a widely used process which is applied in a variety of branches of industry. This is particularly true in the pharmaceutical industry, where typically up to 80% of all intermediate stages and practically all final stages are isolated as solids and processed further or formulated as pharmaceutical preparation forms, respectively. Discharging, metering and mixing are processes which presuppose a movement of the solid bulk material, wherein the interaction forces between the particles and between the particles and the apparatus wall play an important role. In fine-grained substances (<20 μm), the van der Waals forces dominate over gravity. The result of this is that these substances are flowable only to a limited extent or not at all, and thus undesired deposits and blockages in apparatuses and installations can occur.

The van der Waals forces of these critical substances can be influenced by changing the surface morphology of the particles. For example, according to CA2492129 and the corresponding WO 2004/007594, the adhesion forces between the particles and between the particles and the wall can be reduced, for example, by applying nanoparticles on the substrate surface (I. Zimmermann, M. Eber, K. Meyer, Nanomaterials as Flow Regulators in Dry Powders, Z. Phys. Chem. 218 (2004), 51-102). Despite a few studies in literature (S. Jonat, S. Hasenzahl, A. Gray, P. C. Schmidt, Mechanism of Glidants: Investigation of the Effect of Different Colloidal Silicon Dioxide Types on Powder Flow by Atomic Force and Scanning Electron Microscopy, J. Pharm. Sci. 93 (10) (2004), 2635-2644; J. H. Werth, M. Linsenbühler, S. M. Dammer, Z. Farkas, H. Hinrichsen, K.-E. Wirth, D. E. Wolf, Agglomeration of Charged Nanopowders in Suspensions, Powder Technol. 133 (2003), 106-112) which document the change in flow properties of pharmaceutical substances by adding Aerosil™ nanoparticles, to date there has not yet been a commercial or marketable method for improving the flow properties of fine-grained solids.

### DESCRIPTION OF THE INVENTION

Accordingly, the invention serves for providing an improved method for attaching nanoparticles to substrate particles. The invention here particularly proposes to provide the formation of nanoparticles and their attachment to substrate particles by means of plasma-supported chemical deposition from the gas phase.

The following text will define how the terms “nanoparticles” and “substrate particles” are to be understood in connection with this document:

The substrate particles are
solid particles which are treated using the process described in this document. The particles can be organic or inorganic particles, they can consist of only one material (homogeneous) or they can comprise mixtures (heterogeneous), or they can be, for example, coated particles. Possible examples are polymer particles, particles on the basis of organic molecules such as lactose or inorganic substances etc.
particles which do not have any restrictions with respect to the chemical composition and physical properties. For them to be able to definitely withstand the treatment in the plasma or directly after the plasma in afterglow, they should preferably be stable up to 70° C., i.e. the temperature for conversion into another chemical form should lie at least at room temperature, preferably at least 50° C., particularly preferably at least 70° C. The particles are preferably electrically non-conducting.
particles whose characteristic size typically lies in the range from a few micrometers to a few millimeters, but preferably even in the range from a few hundred nanometers (500 nm) to a few hundred micrometers (500 μm). The particles can have different shapes. For example, they can have the form of plates, spheres, rods, flakes, or they can be irregular fragments (for example as a result of a grinding process). They typically have an average diameter (d₅₀) in the range from 1 μm-1 mm, preferably even from 500 nm-500 μm.

The nanoparticles are
solid particles which are produced via a chemical reaction from the monomer, where it may also be a mixture of different monomers or monomers with additives, respectively, or the like.
formations which can comprise individual or a plurality of particles (agglomerate).
particles whose characteristic size is typically less than 1 μm or even smaller than 500 nm. Accordingly, the nanoparticles normally have an average diameter (d₅₀) in the range from 0.5 nm-500 nm. They can be so small that their presence cannot be proven with a scanning electron microscope. The average size of nanoparticles is preferably in the range from 0.5 nm-500 nm, particularly preferably in the range from 1-10 nm. The ideal size of the nanoparticles with respect to the effect on the flowability of the substrate particles depends, inter alia, also on the size and the shape of the substrate particles. The size of the nanoparticles can be adjusted via the process parameters.

It is proposed in particular to form nanoparticles by means of plasma-supported chemical deposition from the gas phase and to attach them to substrate particles.

In concrete terms, a method for forming nanoparticles and their attachment to substrate particles is proposed, which is characterized:
in that a gas stream is guided through a plasma zone in which an electric gas discharge is used to produce an anisothermal plasma, in particular to produce free charge carriers (CC) and excited neutral species (excited particles), wherein a gaseous monomer, which serves as starting material for the chemical reaction for the formation of the nanoparticles, is added to the gas stream before, in (direct plasma enhanced chemical vapour deposition—direct PECVD) or after (remote PECVD) the plasma zone, and wherein the free charge carriers and excited neutral species are used directly in the plasma zone or after the plasma zone to bring the gaseous monomer into a chemically reactive state and to a homogeneous chemical reaction, so that nanoparticles form from the gas phase owing to chemical deposition, and
in that the formed nanoparticles attach to the surface of the substrate particles due to the collision of the two types of particles in a treatment zone through which a substrate particle and/or substrate particle/gas stream is guided under the influence of the gas flow and/or the gravitational force.

It is possible here according to a first preferred embodiment to allow the attachment of the nanoparticles to the substrate particles to take place directly in the plasma zone. This is possible by guiding, in a gas/substrate particle stream under the influence of the gas flow and the gravitational force, the substrate particles through a treatment zone, wherein the gas stream includes, in addition to the substrate particles, a gaseous monomer which serves as starting material for the chemical reaction for forming the nanoparticles; by using an electric gas discharge in the treatment zone in order to produce an anisothermal plasma as the plasma zone, wherein the free electrons, or, respectively, the CC and the excited particles, are used to bring the gaseous monomer into a chemically reactive state and to a homogeneous chemical reaction, with the result that nanoparticles form due to chemical deposition from the gas phase; and by the formed nanoparticles attaching directly to the surface of the substrate particles due to the collision of the two types of particles inside the plasma zone. The fact that a gas/substrate particle stream is guided through the treatment zone has the result that the nanoparticles are formed and the substrate particles are coated quasi in situ with these particles in the treatment zone.

Plasma zone and treatment zone can thus physically coincide and therefore the formation of the nanoparticles and their attachment can take place directly at the same time. It is alternatively possible for the treatment zone to be situated substantially directly downstream of the plasma zone (here referred to as afterglow method), where in the latter case preferably the gas stream from the plasma zone and the substrate particle stream quasi intersect. So in this case only a gas stream without substrate particles is guided through the plasma zone. The gas stream, which now no longer carries the monomer but the nanoparticles formed in the plasma zone, quasi intersects with a gas stream, which carries the substrate particles (substrate particle stream), only directly after the plasma zone. This process is even suitable for substrate particles which are still more temperature-sensitive.

Preferably, the average residence time of the substrate particles in the treatment zone is between 10 ms and 1 s.

For this purpose, it is possible in a preferred embodiment to guide the substrate particles through the treatment zone once. The substrate particles can quasi fall through the treatment zone here. This can preferably be realized in a drop tube reactor. On the other hand it is also possible for the substrate particles in the substrate particle gas stream to rise upwards through the treatment zone. This type of substrate particle guidance occurs preferably in an ascending tube reactor.

It is, however, also possible in a further preferred embodiment for the substrate particles to be guided through the treatment zone a number of times, e.g. periodically, in which case the treatment zone is preferably situated in the ascending tube of a circulating fluidized bed.

In a further embodiment, however, it is likewise possible for the substrate particles to reside in the treatment zone. Here, the treatment zone would preferably be located in a drum reactor or in a fluidized bed reactor.

The substrate particles and the gas stream can be fed in at different locations in the reactor.

In principle, the monomer can be a chemical substance which is polymerized under the influence of the CC and the excited particles produced in the plasma zone or which reacts to form an oxide, preferably silicon oxide (SiOₓ). The latter, because it is chemically inert, appears to be particularly suitable and can be obtained, for example, by means of hexamethyldisiloxane (HMDSO) or mixtures containing this component. However, it is also possible to use other monomers which form nanoparticles under the specified conditions. Examples are alkanes, alkene and alkynes such as ethyne (trivial name: acetylene), but also hydrocarbons with functional groups. Moreover, hydrofluorocarbons, such as C₂F₆, or organometallic monomers, such as already known HMDSO, tetraethoxysilane or titanium(IV) isopropoxide can be used. Silanes or titanium tetrachloride are, however, also feasible, to name but a few. According to this, it is possible for both gaseous and liquid monomers to be used, the latter particularly preferably in the form of a vapour or of an aerosol. With respect to possible monomer systems, reference is made to a compilation by Morosoff (N. Morosoff, An Introduction to Plasma Polymerization, in: Plasma Deposition, Treatment, and Etching of Polymers, Editor: R. d'Agostino, Academy Press, San Diego, 1990), and the systems mentioned therein are expressly incorporated in the disclosure.

The chemical reaction can proceed via a number of reaction stages, and the nanoparticles can collide among each other and agglomerate before they attach to the substrate surface and/or the nanoparticles on the substrate surface collide with other nanoparticles and agglomerate. The free nanoparticles which are not yet attached can be coated by heterogeneous chemical deposition from the gas phase and/or the nanoparticles which are already attached to the substrate surface can be coated by heterogeneous chemical deposition from the gas phase. The substrate surface which is not yet loaded or only to a negligible degree by nanoparticles can also be coated by heterogeneous chemical deposition from the gas phase, and/or the substrate surface can be coated exclusively by heterogeneous chemical deposition from the gas phase.

According to a further preferred embodiment, a microwave coupling, medium or radio frequency coupling or DC excitation is used to produce an electric gas discharge. An anisothermal low-pressure plasma or an anisothermal normal-pressure plasma can thus preferably be present in the plasma zone. The low-pressure plasma is preferably operated at a pressure in the range from 0.27 mbar to 2.7 mbar.

According to a further preferred embodiment, the monomer is fed in in a gas stream; particularly preferably in an inert gas stream (for example Ar), wherein the monomer partial pressure fraction of the total pressure at the point of addition to the reaction volume lies in the range from 1-10% (in particular in the case of HMDSO), particularly preferred in the range from 2-5%.

In general, a method for increasing the flowability appears sensible if substrate particles with an average size in the range from 1 μm-1 mm, or particularly in the range from 500 nm-500 μm, particularly preferred in the range from 5 μm-500 μm, are introduced into the process, wherein the substrate particles are preferably electrically non-conducting. In larger substrate particles, a treatment within the meaning of the invention generally appears to have no substantial advantages because, between substrate particles upwards of a size of 20 μm, the van der Waals forces increasingly lose their importance as compared to the gravitational force. The method is preferably applied in comparatively temperature-sensitive substrate particles, and the substrate particles can be particles, for example, which are stable up to a temperature of at least 70° C. (typical maximum temperature of the heavy particles in an anisothermal low-pressure plasma). With respect to the nanoparticles, it has proven advantageous if these have an average size in the range from 0.5 nm-1 μm or from 0.5 nm-500 nm. The size of the nanoparticles can be adjusted by way of the process parameters, wherein the easily determinable flowability of the treated substrate particles can be used for example to adjust the parameters.

The above-described method is particularly preferably used to increase the flowability of substrate particles.

Furthermore, the present invention relates to an apparatus for carrying out a method as is described above. The apparatus is preferably characterized in that a plasma zone is present through which a gas stream is guided and in which an electric gas discharge is used to produce an anisothermal plasma, in particular to produce free charge carriers and excited neutral species, wherein a gaseous monomer, which serves as starting material for the chemical reaction for the formation of the nanoparticles, is added to the gas stream before, in or after the plasma zone, and wherein the free charge carriers and excited neutral species are used directly in the plasma zone or after the plasma zone to bring the gaseous monomer into a chemically reactive state and to a homogeneous chemical reaction, with the result that nanoparticles form from the gas phase owing to chemical deposition, and that a treatment zone is present through which a substrate particle and/or substrate particle/gas stream is guided under the influence of the gas flow and/or the gravitational force, and in which the formed nanoparticles attach to the surface of the substrate particles due to the collision of the two types of particles.

A first preferred embodiment of the apparatus is characterized in that a first guiding element is arranged, preferably in the form of a tube, in which the substrate particles are guided in the sense of a drop tube or of an ascending tube and in that a second guiding element, which is arranged preferably substantially at right angles to the first guiding element and opens into this first guiding element, preferably in the form of a tube, is present, in which second guiding element the gas stream with the monomers is guided and in which second guiding element the anisothermal plasma zone is arranged such that substantially directly after this plasma zone, the nanoparticles, which are formed there, in the gas stream attach to the surface of the substrate particles by way of the collision of the two types of particles in the treatment zone.

Further preferred embodiments are described in the dependent claims.

The treatment of fine-grained substances, which are flowable only to a limited extent or not at all, in anisothermal plasmas with the aid of chemical deposition of nanoparticles from the gas phase and their attachment to the substrate particle surface is a very promising method for improving flow properties, which had never been considered for these applications until now.

So-called anisothermal gas discharges are characterized in that the electrons and the heavy species are not in thermodynamic equilibrium (A. Grill, Cold Plasma in Materials Fabrication, From Fundamentals to Applications, IEEE Press, Piscataway (1994)). The energy of the system is not distributed uniformly over all types of particles, but mainly concentrated on the kinetic energy of the electrons, whose temperature is of the order of magnitude of 10⁴ or even 10⁵ K. Since the average temperature of the entire system results from the average kinetic energy of all the particles and the temperature of the heavy species is 300-500 K, this type of plasma is suitable particularly for treating temperature-sensitive substances, such as pharmaceutical products. Despite a low system temperature, the kinetic energy of the electrons in the inelastic collision suffices for providing the activation energy for a chemical reaction.

The formation of nanoparticles in the plasma has already been described in various patents (US2005/118094, JP2004024953) and papers. Especially the generation of particles in thermal plasmas has been known for some time (R. M. Young, E. Pfender, Generation and Behavior of Fine Particles in Thermal Plasmas—a Review, Plasma Chem. Plasma Process. 5 (1) (1985), 1-37; N. Rao, S. Girshick, J. Heberlein, P. McMurry, S. Jones, D. Hansen, B. Micheel, Nanoparticle Formation Using a Plasma Expansion Process, Plasma Chem. Plasma Process. 15 (4) (1995), 581-606) and is also used in a wide variety of branches of industry, such as powder metallurgy. The high temperatures of 1000 K and more may result in high conversion rates, but are unsuitable in connection with the treatment of thermally unstable materials.

A wide variety of literature citations relating to the nanoparticle formation in anisothermal plasmas, which is part of the present patent specification, likewise exist.

In the known surface treatment processes, which presuppose a homogeneous coating of the substrate, the particle formation in the plasma is always regarded as an unwelcome disadvantage (G. S. Selwyn, J. Singh, R. S. Bennett, In situ laser diagnostic studies of plasma-generated particulate contamination, J. Vac. Sci. Technol. A 7 (4) (1989), 2758-2765) since undesired material defects can occur due to the particle contamination. However, nowadays the formation of nanoparticles in electric discharges is no longer regarded exclusively as unwanted contamination per se. The small particle size (nanometer range), the uniform particle size distribution or the chemical activity of the particles formed in the plasma can thus be considered to be useful properties (H. Kersten, G. Thieme, M. Fröhlich, D. Bojic, D. H. Tung, M. Quaas, H. Wulff, R. Hippler, Complex (dusty) plasmas: Examples for applications and observation of magnetron-induced phenomena, Pure Appl. Chem. 77 (2) (2005), 415-428). The formation of particles was investigated both for radio frequency and for microwave couplings, wherein process parameters such as system pressure, introduced energy, temperature, residence time and monomer concentration were varied (T. Fujimoto, K. Okuyama, M. Shimada, Y. Fujishige, M. Adachi, I. Matsui, Particle generation and thin film surface morphology in the tetraethylorthosilicate/oxygen plasma enhanced chemical vapour deposition process, J. Appl. Phys. 99 (5) (2000), 3047-3052; A. Bouchoule, A. Plain, L. Boufendi, J. Ph. Blondeau, C. Laure, Particle generation and behavior in silane-argon low-pressure discharge under continuous or pulsed-frequency excitation, J. Appl. Phys. 70 (4) (1991), 1991-2000; J. H. Chu, L. I, Fine silicon oxide particles in rf hollow magnetron discharges, J. Appl. Phys. 74 (7) (1993), 4741-4745; S. Schlabach, V. Szabo, D. Vollath, A. Braun, R. Clasen, Structure of Alumina and Zirconia Nanoparticles Synthesized by the Karlsruhe Microwave Plasma Process, Solid State Phenomena, 99-100 (2004), 191-196).

Possible arrangements of apparatus and reactor types for the plasma treatment of solid particles are described, inter alia, in the following patent documents: EP 0 807 461, U.S. Pat. No. 5,620,743, U.S. Pat. No. 4,685,419, U.S. Pat. No. 5,234,723 and US 2004/182293. The least common ones are batch reactors with stirring element (J. W. Kim, Y. S. Kim, H. S. Choi, Thermal characteristics of surface-crosslinked high density polyethylene beads as a thermal energy storage material, Korean J. Chem. Eng. 19 (4) (2003), 632-637) which permit only an irregular treatment of the particles since the particles in these reactors form a body which comes into contact with the plasma only on the surface.

A similar point applies to drum reactors (U.S. Pat. No. 5,925,325) which permit a high throughput performance.

The circulating fluidized bed (M. Karches, Ch. Bayer, Ph. Rudolf von Rohr, A circulating fluidised bed for plasma-enhanced chemical vapour deposition on powders at low temperatures, Surf. Coat. Tech. 119 (1999), 879-885) here offers, as compared to the conventional fluidized bed (Ch. Bayer, M. Karches, A. Matthews, Ph. Rudolf von Rohr, Plasma Enhanced Chemical Vapor Deposition on Powders in a Low Temperature Plasma Fluidized Bed, Chem. Eng. Technol. 21 (5) (1998), 427-430), the advantages that a more homogeneous particle treatment and a narrower residence time distribution can be achieved.

The continuous drop tube reactor (C. Arpagaus, A. Sonnenfeld, Ph. Rudolf von Rohr, A Downer Reactor for Short-time Plasma Surface Modification of Polymer Powders, Chem. Eng. Technol. 28 (1) (2005), 87-94) offers the possibility of a homogeneous short-term treatment of the particles.

It is the idea of the invention that nanoparticles are deposited from the gas phase due to a non-thermal (i.e. anisothermal) plasma and attach to the substrate particles in the same process step in order to improve for example the flow properties of fine-grained substances in this manner. Treatment of temperature-sensitive substances is in particular possible because the heavy species in the plasma are not in thermodynamic equilibrium with the electrons.

Particle adhesion effects, which are caused, for example, by electrostatics, liquid junctions or van der Waals forces, result in flowability of solids being strongly decreased. In particle sizes of less than 20 μm, the van der Waals interaction dominates over all the other forces. In addition to the particle radius, it primarily depends on the distance between the substrate particle surfaces. The van der Waals force increases strongly as the particle radius increases and the particle spacing decreases. One possibility of circumventing this problem is to apply even smaller particles with diameters in the nanometer range on the particle surface in order to increase the distance between the substrate particles in this way and thus to decrease the attractive forces.

The invention relates to the process which can be divided into the partial processes of particle formation and attachment. These two steps will be explained in more detail in the next paragraphs.

The formation and the growth of the nanoparticles in the plasma can be divided into four phases (A. Bouchoule, Dusty Plasmas, Physics, Chemistry and Technological Impacts in Plasma Processing, Wiley, Chapter 2 (1999)). In a first step, primary clusters are formed from the atoms and/or molecules of the precursor gas which has formed from the monomer via one or more chemical reactions. While the clusters grow, first particle seeds form, which grow to structures of nanometer size (<5 nm). In the third phase, the primary particles agglomerate, wherein the formations can become up to 50 nm in size. Subsequently, the particles continue to grow independently of one another through deposition from the gas phase.

In the second step of the process, the nanoparticles formed in the first step collide with the substrate particles and adhere to the substrate surface due to the adhesion forces. This presupposes intensive contact of the two species of particles which can be realized, for example, in a fluidized bed.

The two main target variables of the product are the nanoparticle diameter d_{NP} and the number of the nanoparticles n_{NP} per substrate particle surface A_{SP}

$$\frac{{n}_{NP}}{{A}_{SP}} = \frac{2}{\sqrt{3} {d}_{NP}^{2}} ,$$

which have a decisive influence on the flow properties of the substrate particles. In principle, the rule applies that the diameter of the nanoparticles should be chosen such that the substrate particles cannot touch each other directly but in all cases only via nanoparticles. The nanoparticles thus serve to reduce the contact area and to thus largely reduce the undesired adherence between the substrate particles. The ideal population of the surface depends, inter alia, on the shape of the substrate particles and their size, as well as on the size and shape of the nanoparticles. Accordingly, the number of nanoparticles per substrate surface can thus be quasi adjusted indirectly by way of the desired and easily measurable flowability. These target variables can be controlled by way of the process parameters, such as pressure, residence time, gas composition, temperature or introduced energy in the plasma for the gas discharge.

The generally most important parameter is the system pressure because it has a significant influence on the particle formation in anisothermal plasmas. The system pressure or reactor pressure is the pressure in the plasma; that is, preferably the pressure in the plasma zone. Typically, a low-pressure plasma with pressures in the range from 0.27-2.7 mbar is applied for the proposed method. In the pressure range specified, preferably nanoparticles are formed since the average diffusion length (for ensuring homogeneous chemical reactions) is already sufficiently small, while the initially required fragmentation or activation of the monomer (preferably initiated by high-energy electrons) is still sufficiently large due to a sufficient electron density (cf. in this respect N. Morosoff, An Introduction to Plasma Polymerization, in: Plasma Deposition, Treatment, and Etching of Polymers, Editor: R. d'Agostino, Academy Press, San Diego, 1990). For example, tests have shown that at low pressures, a heterogeneous gas phase reaction takes place at the surface of the substrate particles and thus a homogeneous layer formation is promoted there. At higher process pressures, however, the frequency of the particle collisions in the plasma increases, with the result that the homogeneous gas phase reaction preferably takes place and thus the formation of particles is facilitated.

The residence time of the substrate particles to be treated in the reactor, or to be more precise in the treatment zone, and of the gas stream in the plasma zone are likewise important variables of the process. For example, the size of the nanoparticles and the number of nanoparticles per substrate surface can be controlled by way of these parameters. Tests show that a treatment time of the order of magnitude of a tenth of a second suffices to achieve the desired result. However, it is also possible to circulate the substrate particles a number of times through the treatment zone. The longer the residence times in plasma zone and treatment zone, the larger the nanoparticles that form and, respectively, the better the population of the surface. In general it is true to say that a total residence time in the treatment zone and/or in the plasma zone (if appropriate also in the case of cyclic exposition of the substrate particles to be understood as sum, i.e. accumulated) in the range from 10 ms-1 s is suitable. Consequently, the reactor concept must be chosen such that such short residence times can be observed with correspondingly narrow residence time distribution of the substrate particles. Configurations which are suitable therefor are, for example, the drop tube reactor mentioned in the introduction or the circulating fluidized bed mentioned in the introduction, which will both be described in detail further below.

The process described herein offers various advantages:
The flowability of fine-grained substances, in which the van der Waals forces dominate with respect to gravity and the other particle interaction forces, can be improved by the method explained. Hereby, blockages and deposits in apparatuses in processes such as mixing, discharging or metering can be avoided, which is in turn connected to savings in terms of time and costs.
The two partial steps of nanoparticle formation and attachment coincide in one process step or are carried out one directly after the other in the gas stream. An additional processing of nanoparticles, which is in turn connected to adhesion phenomena and to aspects which are dangerous to health, can thus be omitted. Moreover, the risk of a dust explosion is negligibly small in low pressure.
As opposed to methods where the nanoparticles attach to the substrate surface via a mixing process (compare, for example, I. Zimmermann, M. Eber, K. Meyer, Nanomaterials as Flow Regulators in Dry Powders, Z. Phys. Chem. 218 (2004), 51-102), significantly shorter treatment times result (hours as opposed to seconds or fractions of a second) and thus a significant improvement of cost effectiveness.
The low process temperatures (<70° C.) enable temperature-sensitive substrate particles to be treated. As already explained, this is a low-pressure plasma in which substantially only the electrons have a high kinetic energy (temperature equivalent in the range from 1000-10000 K). Accordingly, neither substrate particle, nor monomer, nor nanoparticle is heated as a rule in the process to a temperature above approximately 70° C.

In summary, the preferred method can be characterized as follows:

An apparatus and a method for forming nanoparticles and their attachment to substrate particles, which is characterized by the following features: —the use of a gas/substrate particle stream which guides the substrate particles through the so-called treatment zone under the influence of the gas flow and the gravitational force (e.g. drop tube or ascending tube); —the use of a gas stream which includes, in addition to other species, the gaseous monomer which is used as starting material for the chemical reaction; —the use of an electric gas discharge for producing an anisothermal plasma in which the free electrons (more precisely: CC and excited particles, preferably high-energy electrons) are used to bring the gaseous monomer into a chemically reactive state; —the process of the homogeneous chemical reaction of the reactive species in the gas phase; —the process of the formation of nanoparticles which is caused by the chemical deposition from the gas phase; —the process of attachment of the nanoparticles to the surface of the substrate particles, which is caused by way of the collision of the two types of particles and takes place directly inside the plasma zone.

An apparatus and a method of this type can be characterized in that the process of deposition of the nanoparticles on the surface of the substrate particles takes place outside the plasma zone. It can also be characterized in that, rather than using a reactor which was designed specifically for the method, the described process is integrated in another method step or in another apparatus (e.g. jet mill). It can furthermore be characterized in that, rather than the SiOₓ described in the detailed description of a possible technical implementation of the invention, another reaction product is produced, which forms the basis for the nanoparticle production.

### BRIEF DESCRIPTION OF THE FIGURES

The invention will be explained in more detail below using exemplary embodiments in conjunction with the drawings, in which:

FIG. 1 shows a circulating fluidized bed as possible arrangement for realizing the process; the process, which is described in this document, mainly takes place inside the active plasma zone of the reactor; all essential components relating to the overall arrangement are in each case numbered for the description of the structure;

FIG. 2 shows a drop tube reactor as possible arrangement for realizing the process;

FIG. 3 shows flowabilities of the substrate particles;

FIG. 4 shows flowability as a function of the monomer flow rate; and

FIG. 5 shows flowability as a function of the RF power in the plasma.

### WAYS OF IMPLEMENTING THE INVENTION

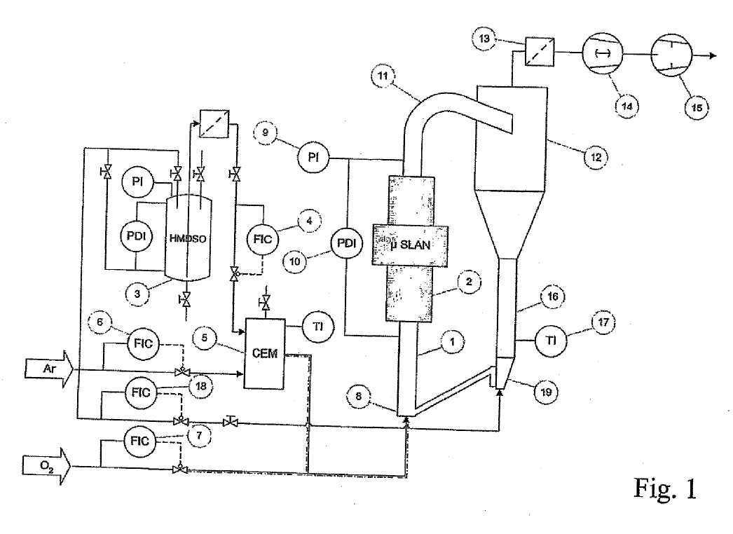

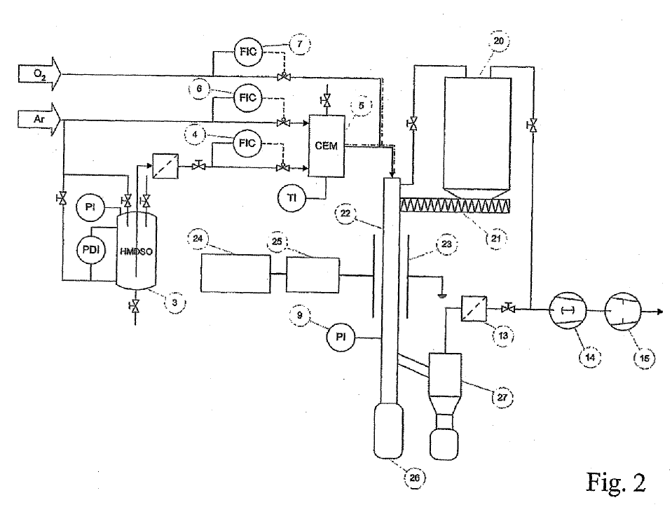

An example of how the invention can be realized will be shown here with reference to the circulating fluidized bed (FIG. 1) and the drop tube reactor (FIG. 2). The monomer used is HMDSO which reacts, under suitable conditions, to SiOₓ and finally attaches in the form of nanoparticles to the surface of the substrate particles to be treated.

### Circulating Fluidized Bed:

At the core of the arrangement is the ascending tube 1 made of fused glass in which the substrate particles to be treated are guided through the plasma zone. The microwave plasma source 2 μSLAN (JE Plasma Consult, Germany) is used to emit the microwaves into the plasma zone according to a ring resonator/slot antenna principle, as a result of which the plasma can form inside the fused tube. The microwave excitation occurs at a frequency of 2.45 GHz, with the forward power being capable of being varied between 0 and 2000 W. A general observation can be that coupling in more power also leads to a better flow behavior of the substrate particles.

The process gas is composed of argon, oxygen and HMDSO. The latter is stored in a pressure vessel 3 in liquid form and guided, via a mass flow regulator 4, to the evaporation module 5 where the monomer evaporates. In general it is true that the achieved flow behavior of the treated substrate particles can be better, the more monomer is fed in (normally approximately a monomer partial pressure fraction of the overall pressure, i.e. of the system pressure, of 2% to 10%). At the same time, argon is admixed at this place in the evaporation module. Its flow rate is likewise adjusted by way of a mass flow regulator 6. In order to prevent recondensation of the monomer, the gas mixture is heated until it enters the reactor. In addition, the oxygen is admixed by way of another mass flow regulator 7. Finally, the process gas flows via a sinter plate 8 (this plate only lets gas through and keeps substrate particles back) into the reactor and thus leads to a dispersion of the solid. Due to the frictional forces of the gas, the substrate particles are accelerated in the vertical direction. The substrate particles are introduced in this reactor before the start of a batch and subsequently circulated in the circuit denoted with the reference symbols 1, 2, 11, 12, 16, 19. In other words, this reactor is a reactor in which the substrate particles are guided a number of times through the treatment zone and it is a process which cannot normally be carried out continuously.

At the end of the ascending tube, the system pressure, or process pressure, is measured using a capacitive pressure probe 9. The solid mass flow in the tube can be estimated by means of determining the pressure drop 10 across the plasma zone.

After the plasma zone, the gas/particle stream passes into the cyclone separator 12 via the bent inlet 11. The gas is discharged by the vacuum pumps through a dust filter 13. The two-stage pump system comprises a Roots pump 14 and a two-stage rotary vane pump 15.

The particles separated in the cyclone are stored in the drop tube 16. In this region of the reactor, the temperature of the substrate particles is likewise measured using thermocouple 17. An additional stream of argon, which is controlled by way of a mass flow regulator 18, fluidizes the fixed bed in the lowermost region of the drop tube 19 and thus enables the substrate particles to be uniformly guided back into the ascending tube. It is possible by way of the argon stream to control the degree of fluidization of the particulate bed and thus also the mass flow of the particles which are guided back into the ascending tube.

### Drop Tube Reactor:

The process gas feed 3-7 and the pump system 13-15 are identical to those of the circulating fluidized bed and will not be explained in more detail here.

As opposed to the circulating fluidized bed, the drop tube reactor can be operated continuously. The untreated substrate particles are stored in a storage container 20 before they are transported, via a speed-controllable conveying screw 21 into the drop tube 22 made of fused glass.

The process gas, which flows into the drop tube from above, accelerates the substrate particles in the vertical direction downward. The solid is homogeneously dispersed over the tube cross section via a nozzle (cf. in this respect for example C. Arpagaus, A. Sonnenfeld, Ph. Rudolf von Rohr, A Downer Reactor for Short-time Plasma Surface Modification of Polymer Powders, Chem. Eng. Technol. 28 (1) (2005), 87-94), so that a homogeneous particle treatment can be achieved. Subsequently, the gas/solid mixture flows through the reaction zone, where the plasma is produced by way of two capacitively coupled electrodes 23 (normally copper electrodes). Here, as opposed to the microwave, the energy is produced using a radio frequency generator (13.56 MHz, PFG 300, Hüttinger Electronic, Germany), wherein the forward power can be adjusted to be between 0 and 300 W. The matching network 25 (PFM 1500A, Hütttinger Electronic, Germany) between generator 24 and powered electrode ensures the impedance matching.

Below the plasma zone, the process pressure is measured using capacitive pressure probe 9. The major part of the treated substrate particles is collected in a collection container 26. The remaining solid is separated off by way of the cyclone 27.

Accordingly, in the drop tube reactor the substrate particles are not treated cyclically, but the substrate particles rather drop once through the drop tube for the coating with nanoparticles. However, the process is a continuous process, as opposed to the circulating fluidized bed.

### APPLICATION EXAMPLE 1

A model substance (a-D-lactose monohydrate, d₅₀=5.5 μm) is intended to be used to show how the flow properties of solids can be significantly improved using the present process.

The particles are treated in the above-described drop tube reactor.

The sequence of the treatment process can be described as follows:
Once the storage container is filled with the untreated lactose particles, the reactor is sealed in a vacuum-tight manner and the vacuum pumps are switched on. The recipient is evacuated up to an absolute pressure of 0.05 mbar.
The mass flow regulators are adjusted such that 50 sccm of argon and 1030 sccm (standard cubic centimeters per minute) of oxygen flow into the reactor. A process pressure of 2 mbar is set, which is kept constant for the further course of the test.
The RF generator (forward power 100 W) is switched on and the capacities of the matching network are set such that the reflected power is <10 W. Thus, an effective power of >90 W is produced. The plasma ignites.
The mass flow regulator for the monomer is adjusted such that 103 sccm of HMDSO (>98.5%, Fluka) are admixed to the process gas stream.
After a stationary state is established in the reactor, the conveying screw for the feed of solids can be switched on, so that 1.3 kg of lactose per hour are continuously guided through the reactor (residence time t≈0.1 s).
180 s after the conveying screw is switched on, it is switched off again. No more solid is conveyed.
The feed of the monomer is interrupted and the RF generator is switched off. The plasma extinguishes.
The remaining process gas feed (argon, oxygen) is interrupted and the valve between pump and recipient is closed.
The reactor can now be brought to atmospheric pressure and the treated lactose can be removed from the collection container.

### Results:

The flowability (ff_{c}, for the definition cf. D. Schulze, Zur Fliessfähigkeit von Schüttgütern—Definition und Messverfahren [Regarding the flowability of loose materials—definition and measurement method], Chem. 1 ng. Tech. 67 (1) (1995), 60-68) of the treated and untreated lactose is measured using a ring shear tester (RST-XS, Schulze Schüttgutmesstechnik, Germany, cf. also D. Schulze, A. Wittmaier, Flow Properties of Highly Dispersed Powders at Very Small Consolidation Stresses, Chem. Eng. Technol. 26 (2) (2003), 133-137). The shear cell used therefor has a capacity of 30 ml. The initial shear stress applied in the measuring procedure is 5000 Pa, where final shear stresses of 1000, 2500 and 4000 Pa are selected.

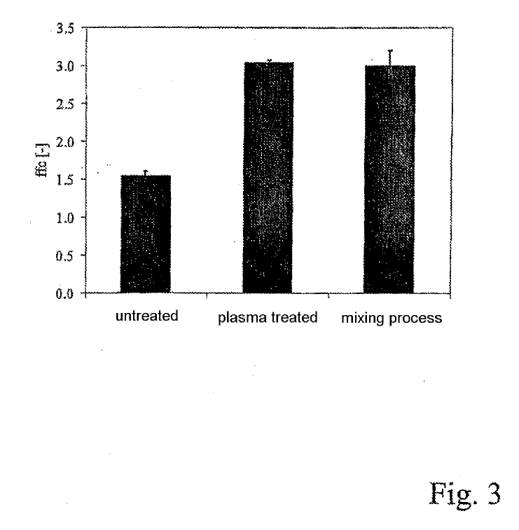

The measured flowabilities can be gathered from FIG. 3. The error bars refer to a 95% confidence interval. It can be seen that the flowability of the untreated lactose can be improved by the described plasma process from 1.5 (very cohesive) to 3 (cohesive). Illustrated in comparison therewith is the flowability of lactose particles which were treated with Aerosil™ in a conventional mixing process (mixing time: 8 h) (cf. for example P. Reichen, Tailoring Particle Properties of Fine Powders by Surface Modifiers, Private Commun., Diploma Thesis, ETH Zürich 2005).

### APPLICATION EXAMPLE 2

A parameter study is used to show to what extent the monomer flow rate affects the flow properties of the model substance (α-D-lactose monohydrate, d₅₀=5.5 μm). The design of the reactor and the sequence of the treatment process are identical to those from the application example 1, except that the process gas composition is varied.
In order to be able to ensure a constant oxygen to HMDSO ratio of 10, the oxygen flow rate (170-1030 sccm) is correspondingly matched to the monomer flow rate (17-103 sccm).
In order that the residence time in the plasma zone remains constant for all parameter settings, the speed of the process gas in the drop tube must be kept constant. Accordingly, the oxygen/HMDSO mixture is supplemented by argon (50-995 sccm), so that a constant gas flow of 1083 sccm is established. At a process pressure of 2 mbar, this corresponds to a gas speed of approximately 8 m/s.

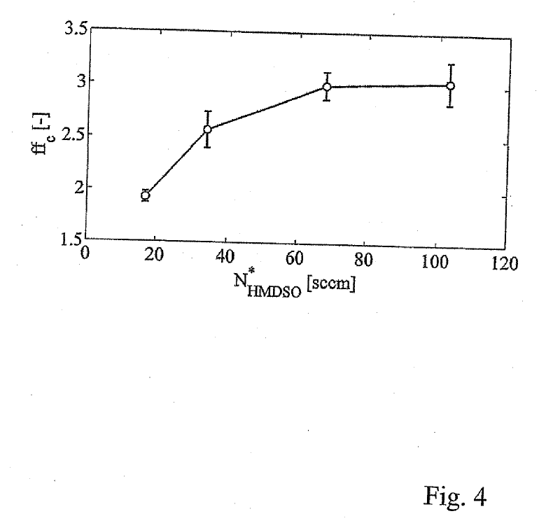

The flowabilities of the treated powders are measured using the method described in application example 1. FIG. 4 shows that the flowability increases as the HMDSO flow rate increases, which can be based on an increased separation rate with increasing partial pressure of the monomer.

### APPLICATION EXAMPLE 3

Another parameter study is used to show to what extent the RF power affects the flow properties of the model substance (α-D-lactose monohydrate, d₅₀=5.5 m). The design of the reactor and the sequence of the treatment process are identical to those from the application example 1, except that the forward power of the RF generator is varied.
For this parameter study, the RF forward powers of 50 W, 100 W and 200 W are set. The capacities of the matching network are adjusted such that the reflected power is <10 W. The result is effective powers of >40 W, >90 W and >190 W.

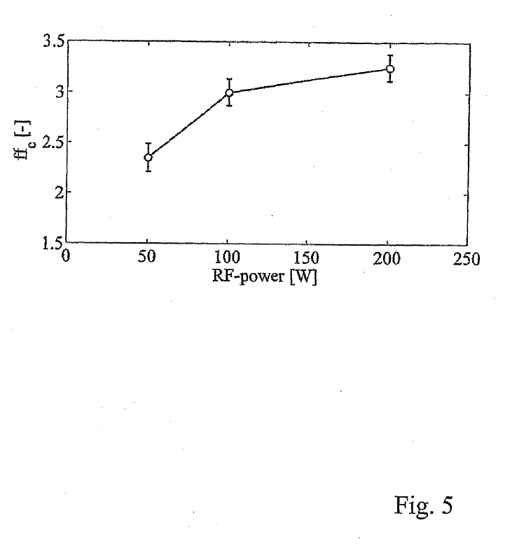

The flowabilities of the treated powders are measured using the method described in application example 1. FIG. 5 shows that the flowability increases as the RF power increases. The higher power results in greater fragmentation of the monomer and thus to an increased separation rate. The values illustrated in FIG. 5 relate to the forward power of the RF generator.

### LIST OF REFERENCES

1 ascending tube
2 microwave plasma source
3 pressure vessel
4 mass flow regulator
5 evaporation module
6 mass flow regulator
7 mass flow regulator
8 sinter plate
9 capacitive pressure probe
10 measurement pressure drop
11 bent inlet
12 cyclone separator
13 dust filter
14 Roots pump
15 rotary vane pump
16 drop tube
17 thermocouple
18 mass flow regulator
19 fluidization zone
20 storage container
21 conveying screw
22 drop tube
23 electrodes
24 generator
25 matching network
26 collection container
27 cyclone

1. A method for forming nanoparticles and their attachment to substrate particles, wherein
a gas stream is guided through a plasma zone in which an electric gas discharge is used to produce an anisothermal plasma, to produce free charge carriers and excited neutral species, wherein a gaseous monomer, which serves as starting material for the chemical reaction for the formation of the nanoparticles, is added to the gas stream before, in or after the plasma zone, and wherein the free charge carriers and excited neutral species are used directly in the plasma zone or after the plasma zone to bring the gaseous monomer into a chemically reactive state and to a homogeneous chemical reaction, so that nanoparticles form from the gas phase owing to chemical deposition, and
wherein the formed nanoparticles attach to the surface of the substrate particles due to the collision of the two types of particles in a treatment zone through which a substrate particle and/or gas/substrate particle stream is guided under the influence of the gas flow and/or the gravitational force.

2. The method as claimed in claim 1, wherein, in a gas/substrate particle stream under the influence of the gas flow and the gravitational force, the substrate particles are guided through a treatment zone, wherein the gas stream includes, in addition to the substrate particles, a gaseous monomer which serves as starting material for the chemical reaction for forming the nanoparticles; wherein an electric gas discharge is used in the treatment zone in order to produce an anisothermal plasma as the plasma zone, wherein the free electrons, or, respectively, the charge carriers and the excited neutral species, are used to bring the gaseous monomer into a chemically reactive state and to a homogeneous chemical reaction, with the result that nanoparticles form due to chemical deposition from the gas phase; and wherein the formed nanoparticles attach directly to the surface of the substrate particles due to the collision of the two types of particles inside the plasma zone.

3. The method as claimed in claim 1, wherein plasma zone and treatment zone physically coincide or wherein the treatment zone is situated substantially directly downstream of the plasma zone, where in the latter case preferably the gas stream from the plasma zone and the substrate particle stream intersect.

4. The method as claimed in claim 1, wherein the substrate particles are guided once through the treatment zone, wherein the treatment zone is preferably a drop tube or an ascending tube.

5. The method as claimed in claim 1, wherein the substrate particles reside in the treatment zone, wherein the treatment zone is preferably a drum reactor or a fluidized bed.

6. The method as claimed in claim 1 wherein the solid particles are guided through the treatment zone a number of times, e.g. periodically, wherein the treatment zone is preferably an ascending tube of a circulating fluidized bed.

7. The method as claimed in claim 1, wherein the substrate particles and the gas stream are fed in at different locations in the reactor.

8. The method as claimed in claim 1, wherein a fluid monomer is used, particularly preferably in the form of an aerosol.

9. The method as claimed in claim 1, wherein the chemical reaction proceeds via a number of reaction stages.

10. The method as claimed in claim 1, wherein the nanoparticles collide among each other and agglomerate before they attach to the substrate surface and/or wherein the nanoparticles on the substrate surface collide with other nanoparticles and agglomerate.

11. The method as claimed in claim 1, wherein the free nanoparticles which are not yet attached are coated by heterogeneous chemical deposition from the gas phase and/or wherein the nanoparticles which are already attached to the substrate surface are coated by heterogeneous chemical deposition from the gas phase.

12. The method as claimed in claim 1, wherein the substrate surface which is not yet loaded or only to a negligible degree by nanoparticles is also coated by heterogeneous chemical deposition from the gas phase, and/or wherein the substrate surface is coated exclusively by heterogeneous chemical deposition from the gas phase.

13. The method as claimed in claim 1, wherein a microwave coupling, medium or radio frequency coupling or DC excitation is used to produce an electric gas discharge.

14. The method as claimed in claim 1, wherein the monomer is HDMSO or a mixture containing HDMSO.

15. The method as claimed in claim 1, wherein an anisothermal low-pressure plasma or a normal-pressure plasma is present in the plasma zone.

16. The method as claimed in claim 1, wherein the low-pressure plasma is operated at a pressure in the range from 0.27 mbar to 2.7 mbar.

17. The method as claimed in claim 1, wherein the monomer is fed in a gas stream, particularly preferably in an inert gas stream, with a content, based on the system pressure, in the range from 1-10%, preferably in the range from 2-5%.

18. The method as claimed in claim 1, wherein substrate particles with an average size in the range from 500 nm-500 μm, preferably in the range from 5 μm-500 μm, are introduced into the process, wherein the substrate particles are preferably electrically non-conducting.

19. The method as claimed in claim 1, wherein the substrate particles are particles which are stable up to a temperature of at least 70° C., wherein they are preferably pharmaceutically active components.

20. The method as claimed in claim 1, wherein the nanoparticles have an average size in the range of less than 500 nm and in that the lower limit of the size of the nanoparticles is given by the corresponding molecule size of the substance deposited in the process, wherein a range from 0.5 nm-0.5 μm is preferred for the average size.

21. The method as claimed in claim 1, wherein the average residence time accumulated in the case of periodic operation in the treatment zone lies in the range from 10 ms-1 s.

22. Method as claimed in claim 1, for increasing the flowability of substrate particles.

23. An apparatus for carrying out a method as claimed in claim 1, wherein a plasma zone is present through which a gas stream is guided and in which an electric gas discharge is used to produce an anisothermal plasma, in particular to produce free charge carriers and excited neutral species, wherein a gaseous monomer, which serves as starting material for the chemical reaction for the formation of the nanoparticles, is added to the gas stream before, in or after the plasma zone, and wherein the free charge carriers and excited neutral species are used directly in the plasma zone or after the plasma zone to bring the gaseous monomer into a chemically reactive state and to a homogeneous chemical reaction, so that nanoparticles form from the gas phase owing to chemical deposition, and wherein a treatment zone is present through which a substrate particle and/or substrate particle/gas stream is guided under the influence of the gas flow and/or the gravitational force, and in which the formed nanoparticles attach to the surface of the substrate particles due to the collision of the two types of particles.

24. The apparatus as claimed in claim 23, wherein a first guiding element is arranged, preferably in the form of a tube, in which the substrate particles are guided in the sense of a drop tube or of an ascending tube and wherein a second guiding element, which is arranged preferably substantially at right angles to the first guiding element and opens into this first guiding element, is present, in which second guiding element the gas stream with the monomers is guided and in which second tube the anisothermal plasma zone is arranged such that substantially directly after this plasma zone, the nanoparticles, which are formed there, in the gas stream attach to the surface of the substrate particles by way of the collision of the two types of particles in the treatment zone.

25. The apparatus as claimed in claim 23, wherein the described process is integrated in an apparatus, preferably in a jet mill.

26. The apparatus as claimed in claim 23, wherein plasma zone and treatment zone physically coincide or wherein the treatment zone is situated substantially directly downstream of the plasma zone, where in the latter case preferably the gas stream from the plasma zone and the substrate particle stream intersect.

27. A substrate particle which can be produced, or is produced, according to a method as claimed in claim 1.
